(19) United States
(12) Patent Application Publication
(10) Pub. No.: US 2003/0057336 A1
(43) Pub. Date: Mar. 27, 2003

(54) Display hangar for providing anti-tip and locking features for use on pegboard, slat wall and the like

(76) Inventor: Arthur Hochman, Miami, FL (US)

Correspondence Address: Murray Leonard, Patent Agent, 8360 Winter Springs Lane, Lake Worth, FL, 33467, US

(21) Appl. No.: 09/961,667

(22) Filed: Sep. 22, 2001

(51) Int. Cl. F21V 21/00

(52) U.S. Cl. 248/220.21; 248/220.41; 248/220.22; 248/220.31; 248/222.51

(57) ABSTRACT

A single wire is formed into a functional shape, whereby an extended loop or a fixed member on the upper section of the prong contacts the pegboard or slat wall in a manner which prevents tipping and at the same time locks the functional keeper into the pegboard or slat wall, wherein the single piece prong is usually formed from wire stock having a diameter between 0.148 inch to 0.225 inch.

### TECHNICAL FIELD

This invention pertains to display hooks to pegboard, slat wall, and the like, for the purpose of displaying products, for use with other merchandising displays, and for the mounting of tools, hardware, and the like, wherein the display hook or display prong provides anti-tipping and locking features when connected to the pegboard or slat wall by means of a conventional hangar, said hangar is not part of the instant invention.

### BACKGROUND OF THE INVENTION

Pegboard and Slat wall display tools, including hooks, brackets, and hook mounting systems are not new. During the past twenty five years, mass merchandising of small items has been by means of wall-mounted pegboards and slat wall, employing appropriate hook and bracket display devices. Hooks and associated brackets are either integral units, or in many cases, the hook and bracket cooperate together to form a functional assembly. The pegboard and their hook systems have also been designed to hold and display cosmetics, tools, cables, wire reels, and a vast multitude of diverse items. The pegboards that are used are provided with a standardized set of openings for pegs or mounting standards which are equidistant from each other in both the vertical and horizontal direction. The dimension of the standard hole spacing has been established by the industry as one inch, center to center, vertically and horizontally.

Products offered for sale in stores are generally packaged in small blister packs which are hung upon hooks. These hooks are mounted upon or affixed the pegboards for display purposes. A simple hook for use with a pegboard is fitted with rear projections which are equal in spacing and slightly smaller in diameter than the openings in the pegboard surface. These projections, which are called “ears” or “tabs”, engage the pegboard openings, by passing through the pegboard openings. The hooks or brackets are thereby attached by inserting the ears or tabs into the pegboard and rotating the bracket until the ears or tabs point upwards on the rear surface of the pegboard. Often, a separate “bracket” or “keeper” is provided for attachment to the pegboard, and the hook element is affixed thereto. The bracket or keeper provides more reliable contact to the pegboard than a simple hook. Hooks which attach directly to the pegboard are cheaper to produce, but these are often flimsy and unstable. Brackets or Keepers have been developed to more securely affix the hook element or prong to the pegboard.

In this industry, Hooks and Prongs are synonymous terms for the hook elements. Brackets and Keepers are synonymous terms for the devices which mount the hook or prong assemblies to the pegboard or slat wall.

The assemblies, which consist of a hook and keeper constitute a complete system, each component cooperating with the other to form a complete hook assembly. It is important to note that although the keeper communicates with the prong for mounting, and the keeper is referenced in claim 1, the keeper itself is not part of the instant invention.

It is important to note that the spacing of the holes in the pegboard have become standardized in the industry, and the hooks and keepers, and other mountings for such hooks may be used on any pegboard. Pegboards may be manufactured of pressed board, Masonite (TM), fiber, wood, plastic, metal, or other materials. Many pegboards that are used for the display of cosmetics employ an electroplated surface to simulate a mirrored or metal surface.

In addition to merchandising applications, the pegboards and slat boards find use in the home and in shops, where tools such as screwdrivers, adjustable wrenches, hammers, punches. and materials such as screws, nails, small parts, and the like may be installed on the pegboards or slat wall, and are thus prominently visible and available. One problem with such use is that when tools are used, removal of the tool often causes the hook to disengage from the pegboard, and both the hook and the tool can fall to the ground. Such disengagement may break the tool, or possibly cause injury to the user.

Since the hooks in the pegboard are capable of being tipped upward, a customer in a store examining products, or selecting an item for purchase, can cause the products on the hook to slide backwards toward the wall, or to actually disengage from the pegboard and fall to the floor.

As the store grows, merchandising space on the limited wall area becomes expensive. The owner attempts to increase the amount of merchandise that can be installed on each hook to maximize the display and to minimize the expense of display. This need has forced the hook length to increase, enabling more merchandise to be displayed on each hook assembly, so that the cost of exposure and presentation to the prospective customer can be reduced. Increasing a hook length from three inches to eight inches or greater makes the hooks unstable and more readily upset or dislodged by a perusing potential customer who often rummages amongst the wall hooks to find the exact product he is searching for. Today, long hooks can range in length from eight inches to twelve inches, thereby aggravating the situation. Some hook assemblies have been manufactured in eighteen inch lengths.

Attempts to solve this disengagement from tipping problem has been attacked by several inventors. In one approach, the hook is fitted with one or more lower straight pins which engage the pegboard, and are intended to help prevent tipping by increasing the difficulty in dislodging the keeper by means of pins or inserts which hold the keeper onto the pegboard at the lower extremity.

In another invention, the bracket that holds the hook is screwed to the pegboard by means of a separate screw and plate. This can certainly prevent tipping, but this approach is costly and labor intensive.

One of the successful approaches has been by this inventor. (U.S. Pat. No. 5,080,238). In his previous solution, the hook arm (also called the prong) fits into a mounting bracket (also called a keeper). The arm sector contains an integral upper block thereon, which, when in place in the keeper, presses against the pegboard, or sits very close to the pegboard panel, rendering the hook assembly un-tippable. The problem with this invention is that the prong and keeper assembly are fabricated of plastic and the system is therefore limited to light-weight articles and relatively small prong length. The prong is generally limited to approximately six or eight inches in length.

As the wall space becomes scarce, the cost of such merchandising becomes very expensive. The cure for this expense is to develop a hook (or prong) which is longer. A length of eight or more inches is typically demanded by the industry. Many hook assemblies have been 12 inches in length, especially those which are used in large discount stores such as Home Depot™ or Wal-Mart.™

The need for an increased length of the hook assembly mandates that plastic is no longer suitable, and longer metal hooks have been developed to decrease the cost of merchandising. The metal hooks are generally fabricated of steel or iron wire, with an iron alloy being preferred due to ease of welding. Various diameters of wire are used to support the load, and wire diameters ranging from 0.148 to 0.225 inch are generally used. These sizes are called “standard”, “medium” and “heavy duty” in this industry. The smaller diameter wires are easier to bend into shape, and these are used when cost is a major factor, and the displayed items are lightweight.

The use of small sized wire is generally limited to cases where the weight of the product being presented is low. The heavier wire is used when the hook must support heavier objects or the length is long, but this is accomplished at an increased cost of the hook or prong member.

As a result, the industry needs a metal or wire hook which provides the strength to support the products being provided for sale, and at the same time, the display assembly must be solid and un-tippable. The hook assembly is also designed to carry a display placard which is used to describe the product, the catalog number, the UPC code, and often, the price of the item. The display placards and the keepers are not part of the instant invention.

FIGS. 11 and 12 show one attempt by this inventor to solve the tipping problem by welding a vertical appendage or finger to the main hook member. The appendage points upwards and towards the pegboard or Slat wall panel and prevents the hook from being tipped up and falling away from the surface of the pegboard or slat wall. While this device works fine, and is one version of the present invention, the welding of a second metal piece onto the hook assembly becomes costly and is therefore less desirable. What was needed was a one-piece hook assembly which contained some form of integral non-tipping feature.

The instant invention is illustrated in FIG. 13. Here an included loop replaces the finger which was illustrated in FIGS. 11 and 12, and when the hook or prong member is in place in the keeper, the loop presses against the pegboard or slat wall, thus preventing tipping.

In addition to preventing tipping, the hook or prong member is sized so that the loop presses against the pegboard, locking the keeper in place, thus preventing the keeper from being removed so long as the prong is in place in the keeper. The present keeper design, however, is configured such that the prong is captivated in the keeper channels by a twist-lock feature.

There are specialized pegboard hooks which provide support for items which are mounted close to the pegboard. Early versions of these small hooks can be seen in U.S. Pat. No. 4,304,382, issued on Dec. 8, 1981. It is important to note that a pegboard mounting system often contains two or more elements which cooperate jointly to form the functioning hook system. These cooperating parts consist of the hook or prong units and the bracket or keeper unit and a display tag. The keeper mounts on the pegboard or slat wall, and the hook or prongs mount on the keeper. The display tag, when used, mounts on one of the prong units.

There are many other pegboard hook designs which have been designed to perform specific jobs. There are long hooks which extend outward from a vertically mounted pegboard for use in merchandise displays. Other hook designs are made for tool storage and the like. A long pegboard hook was designed by this inventor (Arthur Hochman) and was filed on Aug. 24, 1976 and issued as U.S. Pat. No. 4,066,169. This early invention describes a single prong or hook which mounts in a hole in a pegboard. The metal prong portion is further encased in a soft plastic covering in order to minimize the magnitude of personal injury which can arise from contact by a passing person.

During the years which followed, many merchandising hooks have been developed and patented. A typical combination hook and bracket system may be seen in U.S. Pat. No. 4,869,376. by inventors Stanley C. Valiulis, et al. The bracket in this invention was previously invented by Richard Barnes U.S. Pat. No. D272,414, issued Jan. 31,1984, and thereafter slightly modified by Mr. Valiulis. Both inventions were assigned to Southern Imperial Company. This early invention, U.S. Pat. No. 4,869,376, was the prototype of many pegboard systems to follow.

Other hooks have been designed to support tools and to display merchandise. The evolution of product presentation hooks has spawned a new industry. The invention of the long hook however, had several serious failings. The bracket upon which the extended member is supported, mounts in the pegboard holes by means of two protuberances or “ears” or “tabs” which protrude through the pegboard and are then directed upwards on the rear of the pegboard, thus creating a simple mounting. The slat wall assembly uses a flange instead of ears for the mounting.

A prospective customer, while perusing the merchandise, or while selecting one item for purchase, could easily cause the hook to lift, enabling the hook and merchandise to disengage from the perforated pegboard or slat wall and then fall to the floor. When the hook system was used to hold a tool, lifting the tool from the wall would often cause the hook to become loose, and disengage from the pegboard, the tool and the hook wpuld fall to the floor.

Pegboard mounting systems, employ various types of prongs and keepers. Examples of these are illustrated in prior Art, FIGS. 1 through 10, respectively

What was needed was a hook and holder system (in which the hook is also called a “prong”and the holder is also referred to as a “keeper” in this industry) which would be non-tippable and which would lock the keeper to the pegboard after installation of the hook or prong assembly.

This inventor achieved this goal in the invention which is described in U.S. Pat. No. 5,080,238., and illustrated in figure prior art, FIG. 6. In this invention, the keeper was mounted to the pegboard by tabs or “ears” in the usual manner as exemplified in FIG. 1. However, as can be seen in FIG. 6, when the prong assembly was inserted into the keeper, a vertical protrusion on the prong member portion is positioned above the level of the keeper, and the protrusion presses against the pegboard, or is positioned very close to the pegboard surface. This portion of the prong assembly, when inserted into the keeper creates a positive barrier to tipping, and locks the keeper onto the pegboard or slat wall.

The invention described in U.S. Pat. No. 5,080,238. and illustrated in FIG. 6, was commercially successful, and many pegboard and slat wall hook systems were produced using this design.

This simple invention, however had one severe limitation. The product was molded of a thermosetting plastic such as Celcon or Delrin. The strength of the material used in the molded part limited the length of the product carrying portion of the prong section to approximately six inches. The actual product prong portion consists of two elements. A lower element carries the product to be displayed. An upper element carries a placard, which is designed to catch the attention of the shopper. The upper element or section which may contain a placard which displays information about the product, its catalog number, or other information such as pricing. Often, a legend such as “SALE” or a color may be imprinted to catch the attention of the potential customer. The length of this display prong limited the amount of product that could be displayed for sale on any hook.

In a store situation, wall space is expensive, and the industry is demanding a prong assembly which can accept a merchandising length of eight inches or greater. As a result, the plastic item is losing popularity and a metal or “wire” version of the prong section is needed.

A typical prior art prong having a self-contained keeper is illustrated in FIG. 1. This wire assembly is tippable and can be easily dislodged by a potential consumer. FIG. 2 is a simple single hook assembly. This assembly is also easily upset by a user.

FIG. 4 is a plastic version of a display prong. Here, the mounting is a single hook or “ear”. which is inserted in the pegboard. The hook would normally be able to rotate. Such rotation is inhibited by a small ear or projection at the bottom of the hook assembly. It should be noted that the lower ear makes it a little more difficult to dislodge the hook. but the hook can still easily be dislodged with normal effort. There is no anti-tipping feature in this invention.

FIG. 5 is a further variation of the hook and prong assembly. This system can also be dislodged by a vertically oriented impact or displacement by a potential customer.

The instant invention is designed to solve the problem. of the tipping of the hook assemblies and subsequent loss of product.

### PRIOR ART

During the search on this application, 63 previous utility and design patents were uncovered. Not all patents had a direct bearing upon the instant invention of this application.

For the sake brevity, of The following ten U.S. Patents have a direct bearing on the instant invention, and are considered to be relevant prior art for this application. The remaining patents, which are not included in the IDS, are enumerated at the end of this section.

U.S. Pat. No. 6,019,328 STA-PUT PEGBOARD ACCESSORY. Inventor Donald S. Allen, Issued Feb. 1, 2000 This invention describes a wire hangar assembly having a lower portion or tongue (a portion of the wire hangar) which protrudes through the pegboard.

U.S. Pat. No. 5,582,376 STORE DISPLAY FIXTURE WITH MULTIPLE FUNCTION BRACKET. Inventor: David G. Thompson. issued Dec. 10, 1996. This invention describes a multiple function bracket for attachment to a slot wall.

U.S. Pat. No. 5,180,128. PEGBOARD HOOK MOUNTING Inventor Richard C. Mossey. Issued Jan. 19, 1993. This invention depicts a single hook which is secured to a pegboard with two ears.

U.S. Pat. No. 5,109,992 ADJUSTABLE PEG HOOK. Inventor; Byron R. Miller. Issued May 5, 1992. This invention describes a pegboard hook which is engaged on a pair of channel passages on a suspension bracket.

U.S. Pat. No. 5,080,238. DISPLAY HOOK SYSTEM, Inventor: Arthur Hochman, Isssued Jan. 14, 1992. This invention describes a plastic hook and keeper assembly which has a non-tippable and locking feature.

U.S. Pat. No. 4,941,632 PEGBOARD HOOK RETAINING CLIP. Inventor Donald E. Couls et al. This invention describes a clip for use with a small pegboard hook to prevent the hook from being removed from the pegboard unless the clip is swung out of the way

U.S. Pat. No. 3,939,985 HOOK DISPLAY ASSEMBLY. A pegboard mounted rack for displaying merchandise for sale. Inventor, Arthur Hochman Issued Feb. 24, 1976

U.S. Pat. No. 4,923,161 DEVICE FOR COUPLING HOOKS TO A PEGBOARD. Inventor Thomal L. Fahringer. Issued May 8, 1990. In this invention, the hook is firmly attached to the pegboard by the use of an additional screw which is threaded into the pegboard, and onto which the lower end of the pegboard hook is affixed.

U.S. Pat. No. D300,003 This design patent describes a plastic pegboard with the upper hook mounted in a single pegboard opening. A lower peg is employed as an anti-rotation device. This is a rack for displaying merchandise.

U.S. Pat. No. 4,114,763 COMPOSITE UNITS FOR DISPLAYING MERCHANDISE. Inventor Arthur Hochman, issued Sep. 19, 1978. A plurality of hooks may be installed for displaying merchandise such as blister packs.

In addition to those items of relevant art, the following patents were reviewed for content, aand do not impact the instant invention. These patents have not been included in the IDS, in order to avoid prolix.

U.S. Pat. No. 6,234,436:U.S. Pat. No. 6,059,124:U.S. Pat. No. 6,024,230 U.S. Pat. No. 6,003,685:U.S. Pat. No. 5,918,750:U.S. Pat. No. 4,114,763: U.S. Pat. No. 5,913,499:U.S. Pat. No. 5,906,283:U.S. Pat. No. 5,887,731: U.S. Pat. No. 5,833,077:

U.S. Pat. No. 5,791,093.:U.S. Pat. No. 5,775,017:U.S. Pat. No. 5,678,794: U.S. Pat. No. 5,678,702:U.S. Pat. No. 5,881,982:U.S. Pat. No. 5,855,282. U.S. Pat. No. 5,836,459:U.S. Pat. No. 6,227,365:U.S. Pat. No. 6,186,455 U.S. Pat. No. 6,092,674:U.S. Pat. No. 5,765,801:U.S. Pat. No. 5,690,238 U.S. Pat. No. 5,607,132:U.S. Pat. No. 5,607,130:U.S. Pat. No. 5,598,922: U.S. Pat. No. D372,856:U.S. Pat. No. D366,609:U.S. Pat. No. 5,485,930: U.S. Pat. No. 5,407,160:U.S. Pat. No. D355,112:U.S. Pat. No. D352,653: U.S. Pat. No. 5,346,167:U.S. Pat. No. D349,042:U.S. Pat. No. 5,318,187: U.S. Pat. No. 5,253,770:U.S. Pat. No. D332,047:U.S. Pat. No. 5,054,728: U.S. Pat. No. D313,916:U.S. Pat. No. 4,928,912:U.S. Pat. No. 4,762,299: U.S. Pat. No. 4,708,311:U.S. Pat. No. 4,799,637:U.S. Pat. No. 4,662,592: U.S. Pat. No. 4,645,154:U.S. Pat. No. 4,520,978:U.S. Pat. No. 4,516,267: U.S. Pat. No. 4,506,856:U.S. Pat. No. 4,094,415:U.S. Pat. No. 4,015,809: U.S. Pat. No. 4,405,110:U.S. Pat. No. 4,304,382:U.S. Pat. No. 4,303,217. U.S. Pat. No. 3,985,324:

### DISCLOSURE OF THE INVENTION

The need for an un-tippable pegboard and slat wall fixture of extended length has been established in the industry. Thus far, the industry at large has limited success with un-tippable fixtures. This inventor created an un-tippable metal pegboard or slat wall prong. This prong is shown in FIGS. 11 and 12. Although this prong works well, The device is less desirable because a secondary appendage or element must be welded on the main prong body. This addition increases the cost and the complexity of the prong manufacture.

What was needed was a prong which would simultaneously prevent tipping, and at the same time lock the prong fixture and keeper in place, wherein the addition of the un-tippable feature would not significantly increase the cost to manufacture the prong. The second, looped version, of the instant invention, though simple, solves these problems. Both versions of the instant invention work equally as well. The second version, however, is manufactured of a single continuous wire, and is therefore more economical.

Early in the development of this invention, a simple modification to the standard product was tried. This is illustrated in FIGS. 11 and 12. A simple “L” shaped member (5) was welded onto the prong assembly (1). Although this concept was very workable, and solved the tipping and locking problem, this approach was less desirable because the added part had to be welded in place. Welding required fixturing, additional complexity in manufacture, and added cost.

FIG. 13 illustrates the prong (8) of the instant invention and the keeper (13) behind it. The keeper cooperates with the prong to provide a functional display assembly. The instant invention, however, is the modified prong and not the keeper. This assembly is illustrated in FIGS. 13,14, 15, and 16. The invention, however, requires the cooperation between the prong and the keeper.

The salient part of the present invention is illustrated in FIG. 13, as the upper loop (12) which extends upward beyond the keeper (13), and is designed to press against the pegboard (7) when the prong (8) and keeper (13) are in place. This anti-tipping and locking feature is further illustrated in FIGS. 13, 14, 15, and 16.

We can see this feature illustrated most clearly in FIG. 14, where the keeper and prong have been installed on a pegboard using the mounting ears of the keeper. These ears are illustrated in FIG. 13 as item (14). For clarity, a side-view of the invention is shown in FIG. 15. Here we can see the loop (12) of the prong assembly pressing against the pegboard (7). This simple contact prevents the keeper and prong from tipping, and the pressure of the loop against the board locks the assembly in place, preventing untimely removal.

FIG. 16 illustrates the Slat wall version, of the instant invention. The prevention from tipping or being displaced is in the same manner as described for the pegboard in FIG. 14.

FIGS. 18 and 19 illustrate other configurations of prongs which may be used as the present invention. In FIG. 18 we can see a single long prong as item (15) and in FIG. 19 we see a small sized loop prong as item (16). For these types of simple prongs, a generic keeper as is illustrated in FIG. 20 is used. Many different kinds of keepers may be employed. The keepers are not part of the claimed invention.

Although this invention has been shown and described with respect to detailed embodiments thereof, it will be understood by those skilled in the art that various changes in form and detail thereof may be made without departing from the spirit and scope of the claimed invention.

### OBJECTS OF THE INVENTION

The instant invention, entitled: “DISPLAY HANGAR FOR PROVIDING ANTI-TIPPING AND LOCKING FEATURES FOR USE ON PEGBOARD, SLAT WALL AND THE LIKE” was developed to satisfy the following objectives:

1. The hook portion must be of metal, sized to conform with standard wire diameter sizes as used in the pegboard and slat wall industry.

2. The assembly must be non-tippable when displaced by an upward force.

3. The preferred embodiment of the non-tippable element is to be fabricated from a single integral unit with the main hook or prong The preferred assembly must be produced without the need for welding or the addition of any structural members.

4. A welded version is acceptable where cost restraints do not prohibit such an assembly.

5. The system must include a keeper into which the prong or hook assembly mounts. said keeper being locked in place when said prong unit is mounted in said keeper.

5. The keeper may be molded of a plastic material with protrusions or dimples in the prong channels which secure the prong in place within the keeper. Alternatively, the keeper may be fabricated of metal. Although the keeper is an essential part of the product, the keeper is not part of the instant invention, said invention being the prongs having a vertical projection, as described herein.

6. The keeper must be adapted to work with either pegboard or slat wall. Alternatively, a separate keeper has been developed for pegboard and a separate keeper may be designed for slat wall.

7. Simpler prongs may be created using the techniques described for the instant invention, without departing from the intent of the instant invention.

The foregoing and other features of the present invention will become more apparent from the following description and accompanying drawings.

### BRIEF DESCRIPTION OF THE DRAWINGS

FIGS. 1,2,3,4, and 5 exemplify simplified prior art pegboard hooks which do not use a connecting bracket or keeper. The mounting ears are integral to the prong assemblies.

FIG. 7 describes a simple prior art pegboard hook which employs a lower pin to inhibit upward displacement of the hook element.

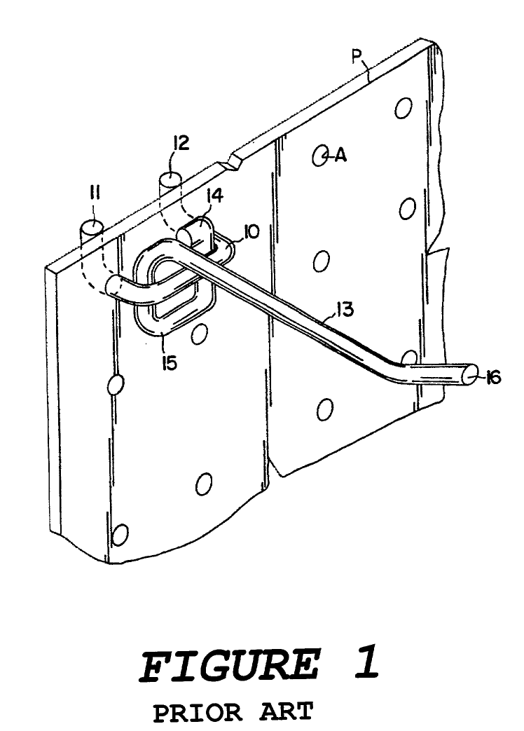

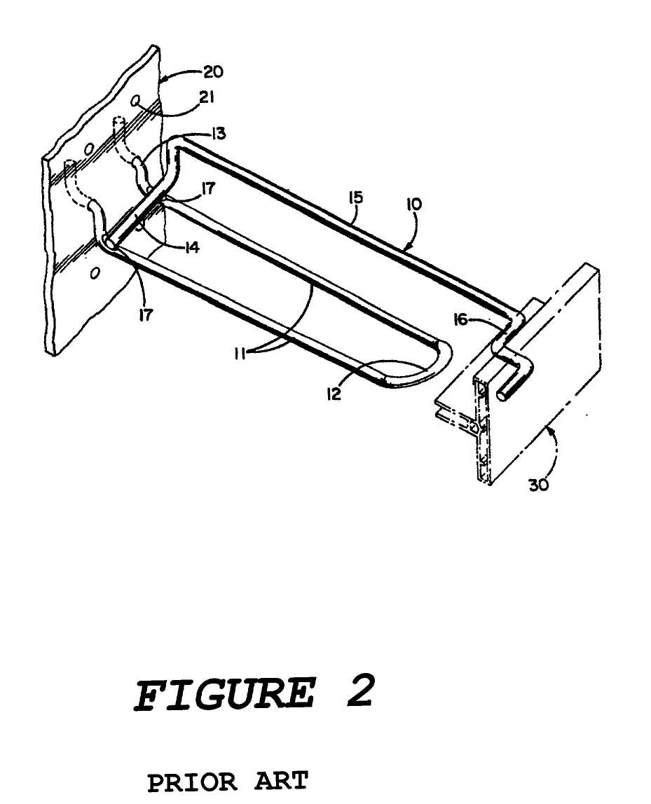

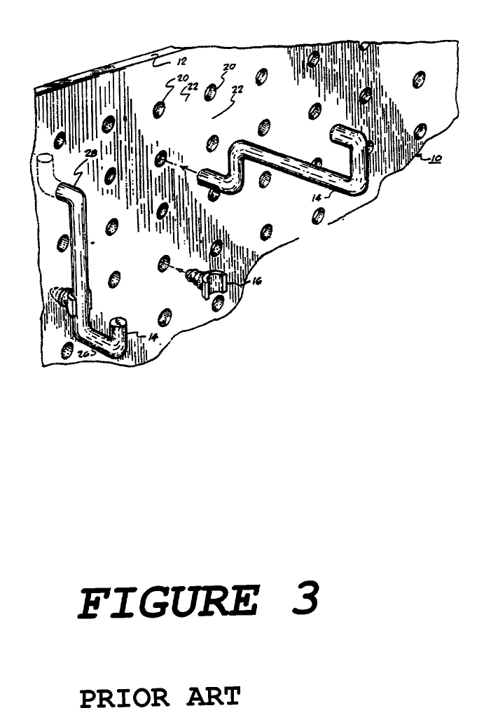

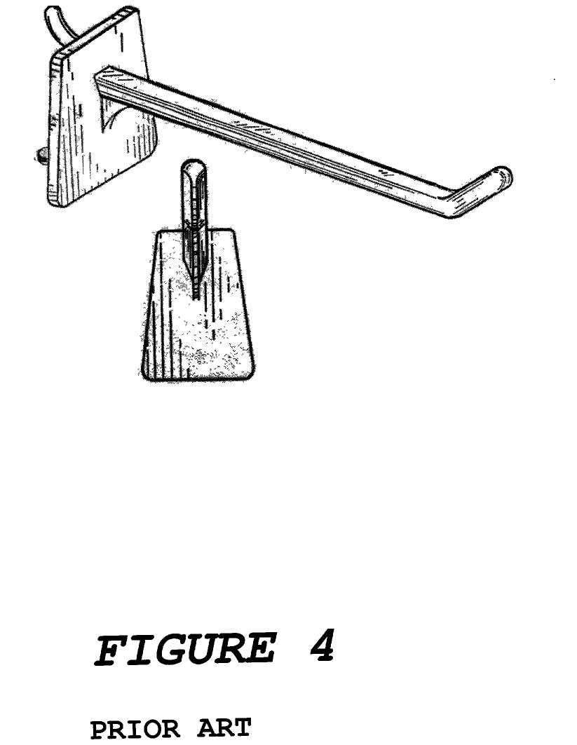

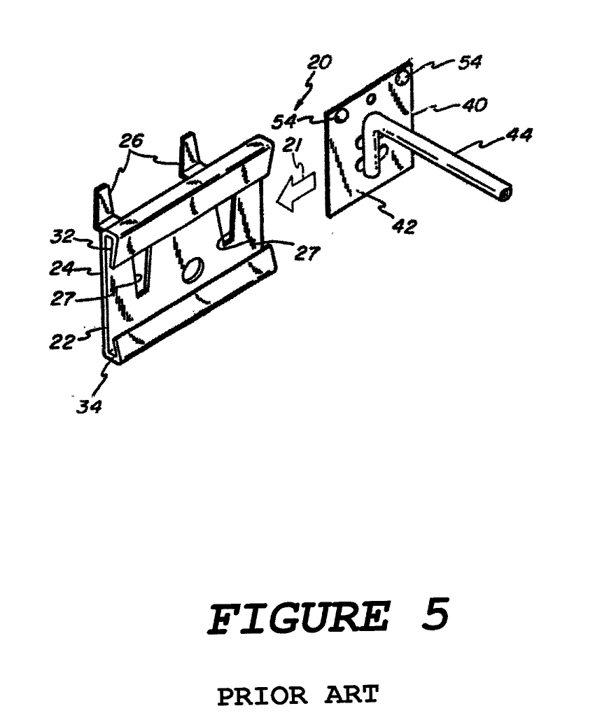

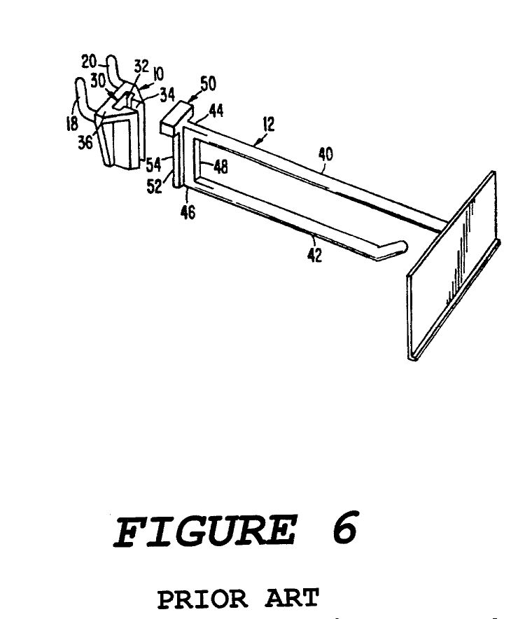

FIG. 4 illustrates a prior art plastic hook assembly having a lower anti-rotation peg in the rear.

FIG. 5 illustrates a prior art system consisting of a bracket and hook assembly. Various hooks, which are mounted to a movable plate may be inserted into the bracket

FIG. 6 depicts a prior art hook and bracket assembly by the present inventor, containing therein an anti-tipping mechanism.

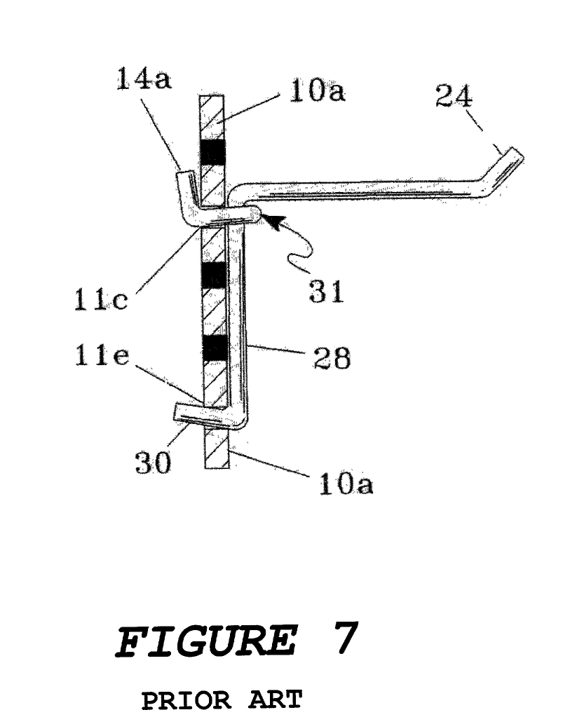

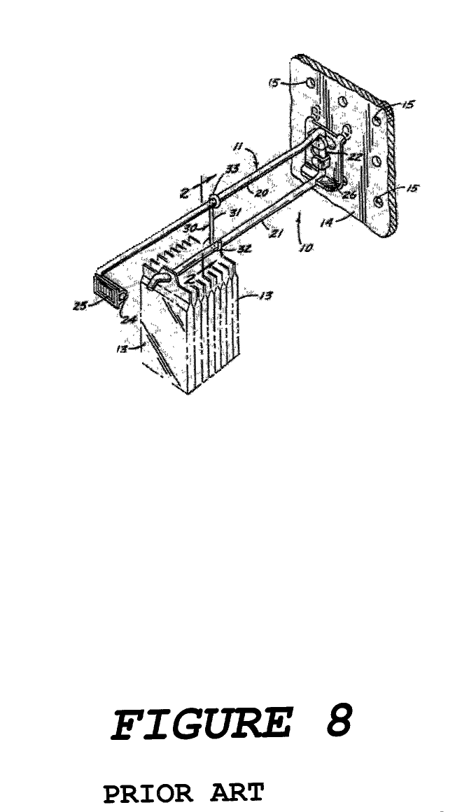

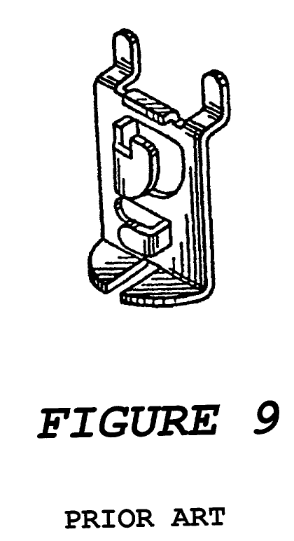

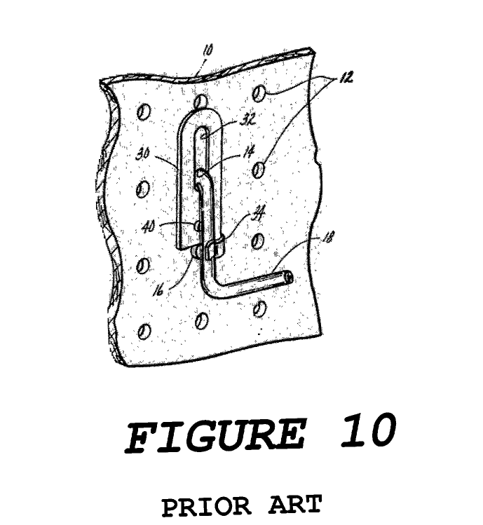

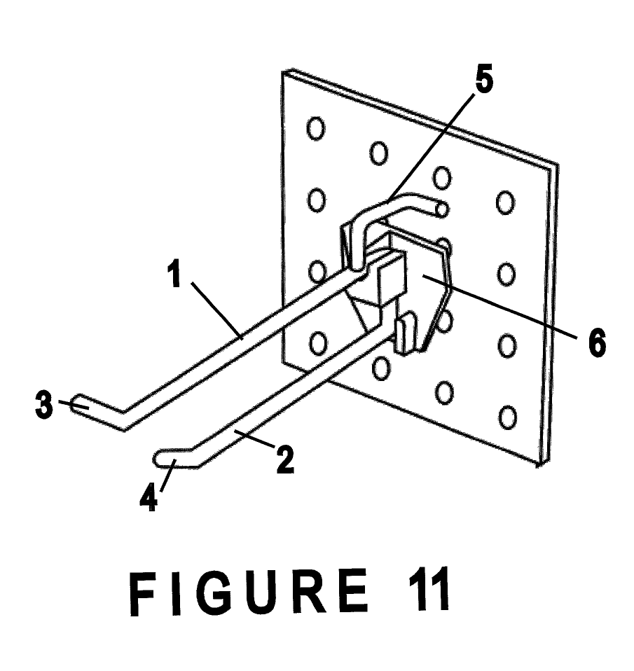

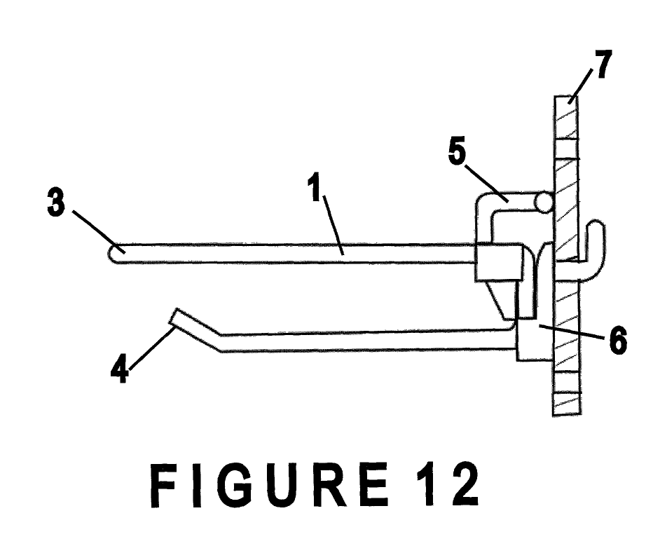

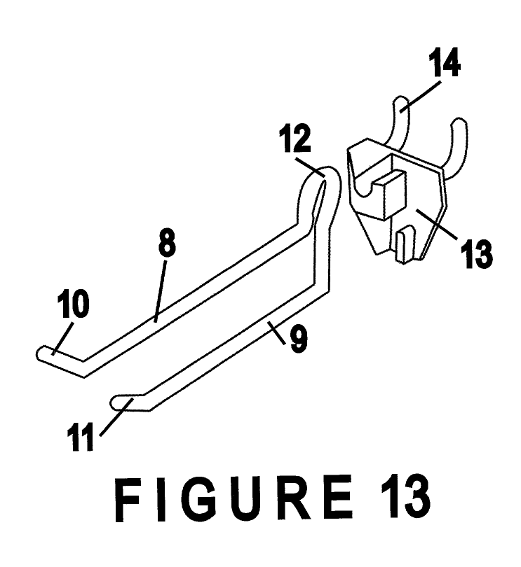

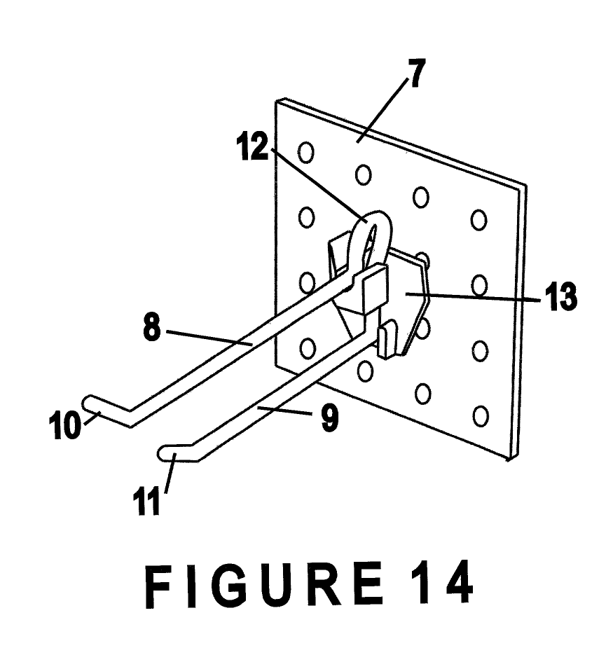

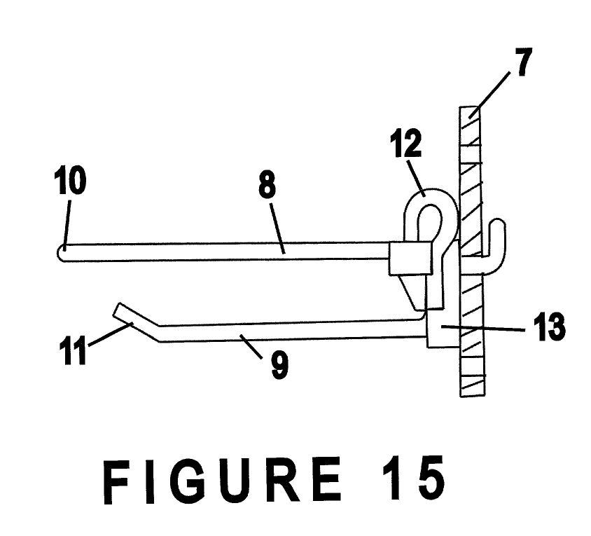

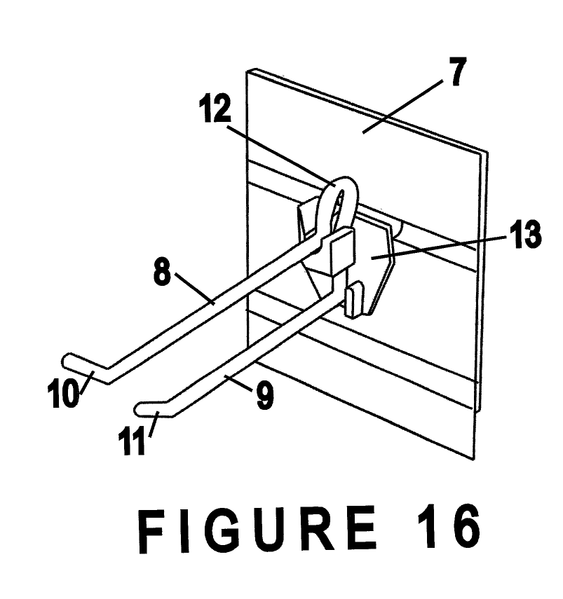

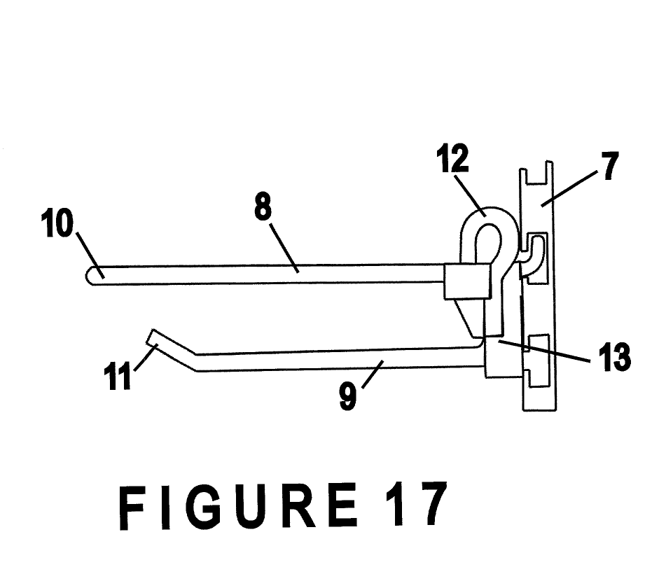

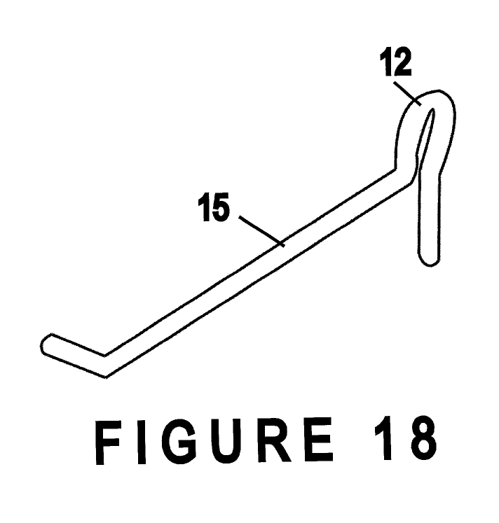

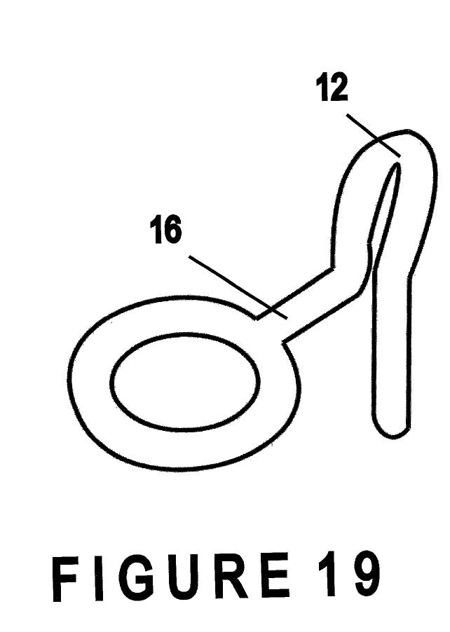

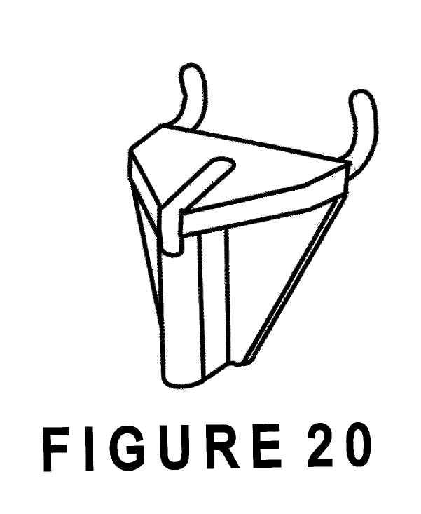

FIG. 7 illustrates a prior art simple hook which employed a lower long peg designed to inhibit tipping and subsequent dislodging. This design was weak because deflecting the hook more than 35 degrees would cause the lower peg to disengage.

FIG. 8 exemplifies a prior art wire hook and keeper. In this application the hook assembly also contained an upper wire for supporting a display tag or plate.

FIG. 9 is a detail of the prior art mounting bracket associated with FIG. 8. Absent are any anti-tipping features.

FIG. 10 depicts a clip for use with a small pegboard hook to prevent the hook from being removed from the pegboard unless the clip is swung out of the way This invention offers an anti-tipping feature.

FIG. 11 illustrates an earlier successful attempt by this inventor at creating the instant invention, a modified hook and keeper wherein the hook provides an anti-tipping feature and a locking mechanism for locking the keeper to a pegboard or slat wall. This approach was less desirable because the anti-tipping part was welded in place, thus increasing the complexity of manufacturing the part, and increased cost to manufacture.

FIGS. 13,14,15, and 16 illustrate the components of the one-piece version of the instant invention.

FIG. 14 depicts the instant invention affixed to a section of pegboard.

FIG. 15 is the same view as FIG. 14, showing a side view, and that the keeper is designed to mount in a section of perf-board.

FIG. 15 is a side view of the assembly seen in FIG. 13, when mounted on a section of pegboard.

FIG. 16 is a side view of the assembly depicted in FIG. 14, except that the prong is mounted on a section of slat wall.

The invention described herein may be used with many variants of prongs, both simple and complex.

FIG. 18 illustrates a single prong and a

FIG. 19 illustrates a single loop prong, as may be used for holding screwdrivers and the like. These simple prongs are used to hold merchandise but without the extra components as are used in display systems. This simpler prong is used to further reduce display costs.

### BEST MODE FOR CARRYING OUT THE INVENTION

This invention, entitled a: “DISPLAY HANGAR FOR PROVIDING ANTI-TIPPING AND LOCKING FEATURES FOR USE ON PEGBOARD, SLAT WALL AND THE LIKE.

In the Best Mode of this invention, a single wire is formed into a functional shape, whereby an extended loop or appendage on the upper section of the prong contacts the pegboard or slat wall in a manner which prevents tipping and at the same time locks the functional keeper into the pegboard or slat wall. The wire is usually formed from stock having a diameter between 0.148 inch to 0.225 inch. A more expensive version also employs a vertically oriented appendage which is welded in place. The welded version, though more costly, can be manufactured without the need for specialized wire bending equipment.

1. We claim a “DISPLAY HANGAR FOR PROVIDING ANTI-TIPPING AND LOCKING FEATURES FOR USE ON PEGBOARD, SLAT WALL AND THE LIKE which utilizes a keeper which affixes to a pegboard or slat wall, the invention consisting of a metal prong, a vertical appendage concomitant with the prong body, a section of the prong for holding merchandise, and a display tag.

2. The DISPLAY HANGAR FOR PROVIDING ANTI-TIPPING AND LOCKING FEATURES FOR USE ON PEGBOARD, SLAT WALL AND THE LIKE of claim 1, wherein the keeper is fabricated or metal or plastic and whereby the keeper is specifically designed to communicate with the metal prong of the instant invention, in a manner which secures the metal prong to the keeper.

3. The DISPLAY HANGAR FOR PROVIDING ANTI-TIPPING AND LOCKING FEATURES FOR USE ON PEGBOARD, SLAT WALL AND THE LIKE of claim 2 wherein the metal prong is formed to contain an integral upper member or loop, and said member or loop has been designed and formed to contact the pegboard or slat wall to which the keeper is affixed in a manner which prevents said prong from tipping when an upward force is applied to said prong.

4. The DISPLAY HANGAR FOR PROVIDING ANTI-TIPPING AND LOCKING FEATURES FOR USE ON PEGBOARD, SLAT WALL AND THE LIKE of claim 3 wherein the metal prong is fitted with a vertically oriented appendage, said appendage providing the non-tippable feature by contacting the peg board or slat wall upon which the keeper is mounted.

5. The DISPLAY HANGAR FOR PROVIDING ANTI-TIPPING AND LOCKING FEATURES FOR USE ON PEGBOARD, SLAT WALL AND THE LIKE of claim 3, wherein said prong vertical appendage, when mounted in said keeper creates a locking force which prevents said keeper from being displaced from the pegboard or slat-wall.

6. The DISPLAY HANGAR FOR PROVIDING ANTI-TIPPING AND LOCKING FEATURES FOR USE ON PEGBOARD, SLAT WALL AND THE LIKE of claim 3, wherein the metal prong and added integral member is fabricated of a wire whose diameter is included within the range from 0.148 to 0.225 inch.
